(19) United States
(12) Patent Application Publication
(10) Pub. No.: US 2004/0137769 A1
(43) Pub. Date: Jul. 15, 2004

(54) Grounding plate of memory card adaptor

(76) Inventor: Tung-Ho Huang, Chung Ho City (TW)

Correspondence Address: BIRCH STEWART KOLASCH & BIRCH, PO BOX 747, FALLS CHURCH, VA, 22040-0747, US

(21) Appl. No.: 10/358,182

(22) Filed: Feb. 5, 2003

(30) Foreign Application Priority Data
Jan. 13, 2003 (TW) 92200541

(51) Int. Cl. H01R 4/66

(52) U.S. Cl. 439/92

(57) ABSTRACT

A grounding plate of memory card adaptor is installed on a guiding arm of a plastic shell of a memory card adaptor. The cross section of the grounding plate is in “L” shape, a horizontal connecting part is on the bottom of the grounding plate; an outward elastic guide is on the center vertical side of the grounding plate; the outward elastic guide is in a horizontally curve shape. The grounding plate connects to the ground and guide the insertion of the memory cards, at the same time reduces the numbers of components and the assembly cost.

### BACKGROUND OF THE INVENTION

I. Field of the Invention

This invention relates generally to a structure of memory card adaptors and, more specifically, to a grounding plate of memory card adaptor that is installed inside the front end of two guiding arms of a memory card adaptor to connects to the ground and guide the insertion of the memory cards, at the same time reduces the numbers of components and the assembly cost.

II. Description of the Prior Art

Heretofore, the structure of a known memory card adaptor, as shown in FIG. 4, consists of a plastic shell (a) and a plurality numbers of connecting pins (b) on the bottom edge of the plastic shell, the connecting pins (b) are soldered firmly onto the circuit board (c) of the interface circuitry, a guiding arm (a1) each is on both sides of the plastic shell (a), a guiding slot (a2) each is inside of the guiding arm (a1), a grounding plate (d) and a memory card guide (e) is on front of the guiding arm (a1), the grounding plate (d) connects to the ground of the circuit board (c) through its bottom (d1), the top of the grounding plate (d) connects to the memory card guide (e); the elastic guide (e1) of the memory card guide (e) is protuberant in the guiding slot (a2), such scheme can make the structure grounded properly and let users insert memory card smoothly.

However, the guiding arm (a1) and on both sides of the plastic shell (a) and the card guiding mechanism (e) are injected from different molds independently, such scheme causes the manufacturing processes tedious and higher component cost, that further reduces the market competition.

### SUMMARY OF THE INVENTION

It is therefore a primary object of the invention to provide a grounding plate of memory card adaptor to combine the grounding plate and the memory card guiding structure into one body to reduce the numbers of components and the assembly cost.

In order to achieve the objective set forth, a grounding plate of memory card adaptor in accordance with the present invention comprises a grounding plate installed on the guiding arm of the plastic shell, the cross section of the grounding plate is in “L” shape, a horizontal connecting part is on the bottom of the grounding plate; an outward elastic guide is on the center vertical side of the grounding plate, the outward elastic guide is in a horizontally curve shape.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an assembly view of the present invention;

FIG. 2 is a perspective view of the grounding plate of the present invention;

FIG. 3 is a perspective view of the present invention;

FIG. 4 is an assembly view of the prior art.

### DESCRIPTION OF THE PREFERRED EMBODIMENT

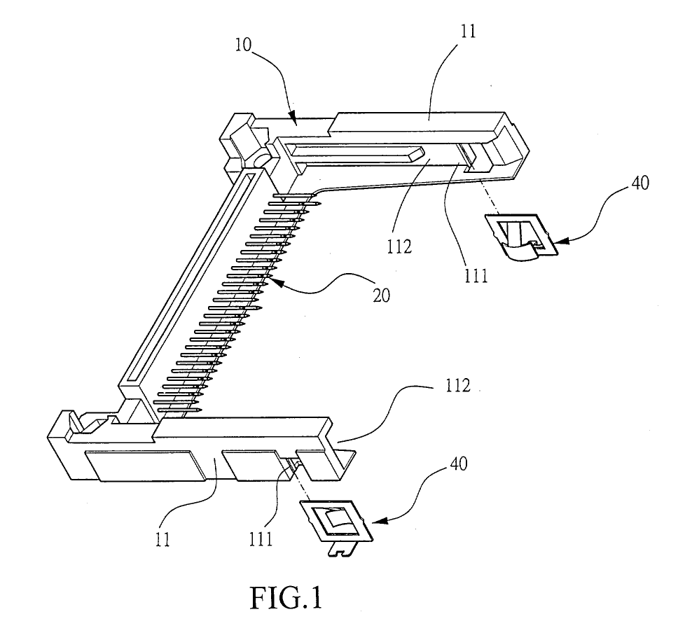

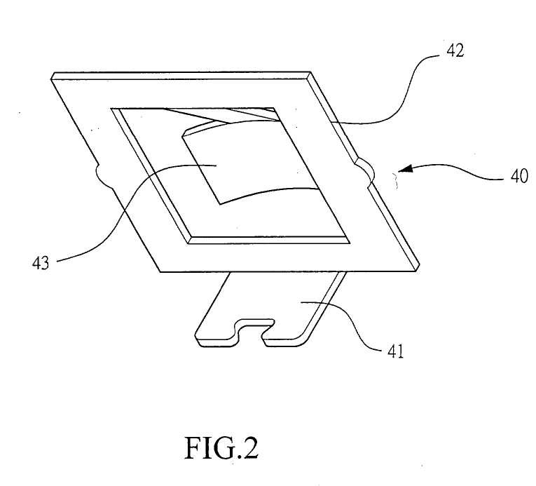

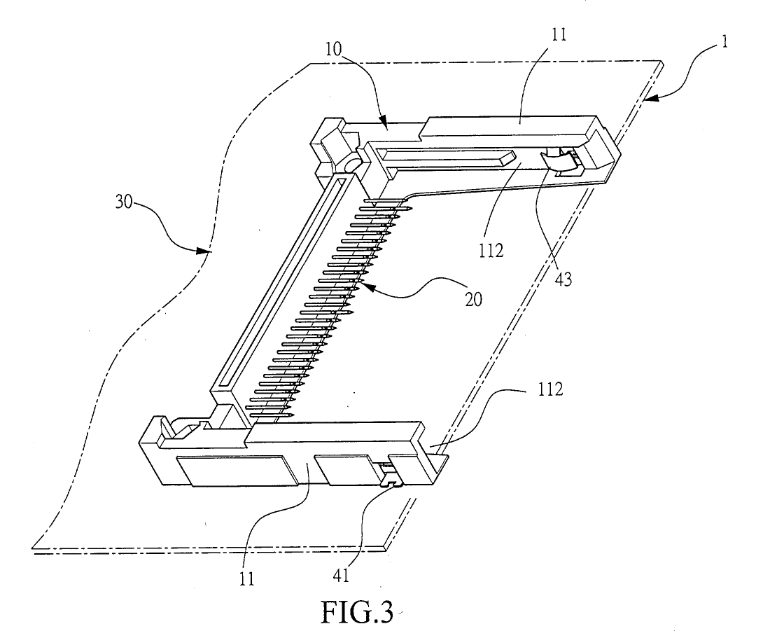

Referring to FIG. 1 to FIG. 3, the memory card adaptor (1) consists of a plastic shell (10) with two guiding arm (11) on both sides and has a plurality numbers of connecting pin (20), the connecting pin (20) are soldered firmly onto the circuit board (30) of the interface circuitry; the major feature: a grounding plate (40) is installed on the guiding arm (11) of the plastic shell (10), the cross section of the grounding plate (40), as shown in FIG. 2, is in “L” shape, a horizontal connecting part (41) is on the bottom of the grounding plate (40); an outward elastic guide (43) is on the center vertical side (42) of the grounding plate (40); the outward elastic guide (43) is in a horizontally curve shape.

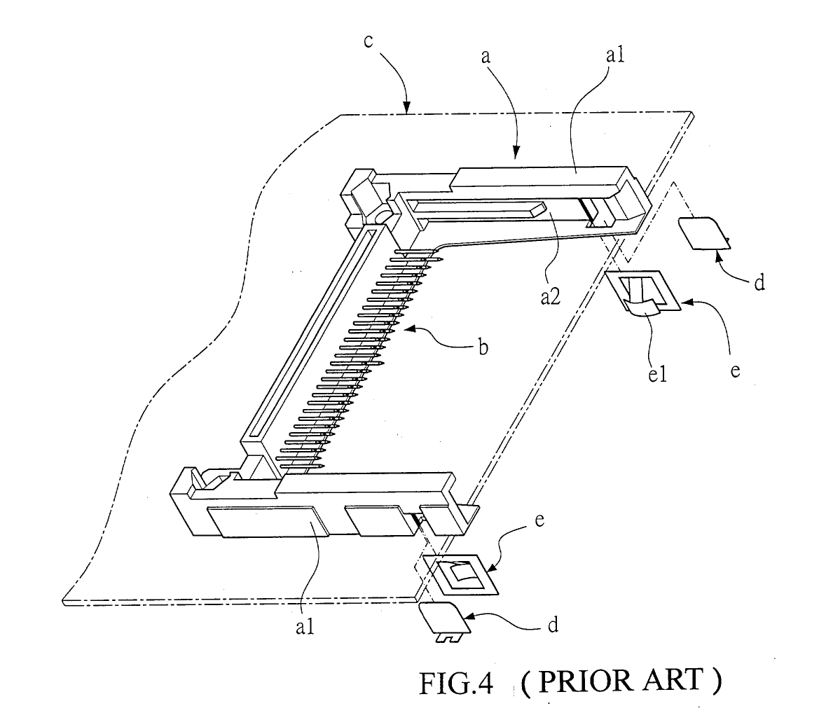

An inserting slot (111) is on the front of the guiding arm (11) of the plastic shell (10), the shape of the inserting slot (111) is corresponding to the grounding plate (40) to have the grounding plate (40) plug in and be fixed from the bottom of the inserting slot (111) rapidly; the outward elastic guide (43) of the grounding plate (40) is on the entrance of the card guide (112) of the guiding arm (11), such structure can make the memory cards connect to the memory card adaptor (1) properly electrically; the whole grounding plate (40) is made from a single sheet metal, such scheme causes less assembly process than the prior art (as shown in FIG. 4) to reduce component and assembly cost.

While a preferred embodiment of the invention has been shown and described in detail, it will be readily understood and appreciated that numerous omissions, changes and additions may be made without departing from the spirit and scope of the invention.

What is claimed is:

1. A grounding plate of memory card adaptor comprising:
a plurality numbers of connecting pin disposed on a plastic shell with two guiding arms on both sides thereof; the improvement of the present invention is characterized in that:
a grounding plate installed on the guiding arm of the plastic shell, the cross section of said grounding plate is in “L” shape, a horizontal connecting part located on the bottom of said grounding plate, an outward elastic guide located on the center vertical side of said grounding plate.

2. The grounding plate of memory card adaptor recited in claim 1, wherein said outward elastic guide is in a horizontally curve shape.
